(19) United States
(12) Patent Application Publication
(10) Pub. No.: US 2015/0295436 A1
(43) Pub. Date: Oct. 15, 2015

(54) APPARATUS, SYSTEM AND METHOD FOR CHARGING A MOBILE DEVICE

(71) Applicant: Misha Ghosh, Charlotte, NC (US)

(72) Inventor: Misha Ghosh, Charlotte, NC (US)

(73) Assignee: IDIYAS LLC, Charlotte, NC (US)

(21) Appl. No.: 14/248,873

(22) Filed: Apr. 9, 2014

(51) Int. Cl. H02J 7/00; H02J 7/35

(52) U.S. Cl. CPC H02J 7/0044; H02J 7/35

(57) ABSTRACT

A charging apparatus, system, and method capable of charging a mobile device. The apparatus, system and method may include at least an attachment mechanism capable of attaching to a surface; a sensor associated with said attachment mechanism and capable of receiving energy generated upon the surface, wherein the received energy is converted to electrical current; and a port electrically communicative with said sensor and capable of receiving the electrical current, and of providing that electrical current to the mobile device.

### BACKGROUND

1. Field of the Disclosure

The present disclosure relates to mobile devices, and, more particularly, to an apparatus, system and method for charging a mobile device

2. Background of the Disclosure

It is well established, particularly with the ubiquitous nature of mobile devices, such as cellular phones and tablet computers, that maintaining a device's charge to allow for use when needed is often difficult in certain circumstances and environments. For example, those who travel frequently in the modern era may make use of in-airport, in-store, in-train station, and the like charging stations, in which a mobile device may be charged, generally for a fee, or weary travelers may be forced to seek out one of a limited number of electrical outlets available in a train station, department store, or airport. Such charging opportunities notwithstanding, it is an inevitability that users who are frequently “on the road” will encounter a situation in which a mobile device is low on charge, is needed for use, and no charging unit, plug, or in-vehicle charger or outlet is available. Further, it may be undesirable for a user to use the aforementioned charging stations when the monetary charges for charging one's mobile device is significant, such as on the order of several dollars or more.

For example, it is often the case that business persons are highly dependent on mobile devices, and frequently travel on airplanes. It is typical in an airplane setting that there is not a charging port available, other than by using other devices available to the traveler. For example, if a traveler is highly dependent on her iPhone, and additionally carries a laptop, to the extent the iPhone loses charge on the plane, the user may plug the iPhone into her laptop to recharge the iPhone. Of course, the laptop, both due to being turned on and due to charging the iPhone, will thereby lose its charge. Consequently, the user may reach her destination having one device with a low level or no charge, and another device with no charge at all, and accordingly the user may have to make a decision as to the relative importance of her devices prior to reaching her destination.

Therefore, the need exists for a simple methodology and apparatus for charging one's mobile device, particularly for a relatively inexpensive per use cost, or at a relatively inexpensive initial cost alone.

### SUMMARY

The present invention is and includes at least a charging apparatus, system, and method capable of charging a mobile device. The apparatus, system and method may include at least an attachment mechanism capable of attaching to a surface; a sensor associated with said attachment mechanism and capable of receiving energy generated upon the surface, wherein the received energy is converted to electrical current; and a port electrically communicative with said sensor and capable of receiving the electrical current, and of providing that electrical current to the mobile device.

The method according hereto may include providing an attachment mechanism attachment capable of attaching to a surface; providing a sensor associated with said attachment mechanism and capable of receiving energy generated upon the surface; converting the received energy to electrical current; and receiving, at a port electrically communicative with said sensor and capable of receiving the electrical current, an electrical connection to the mobile device

Therefore, the present invention provides at least a simple methodology and apparatus for charging one's mobile device, particularly for a relatively inexpensive per use cost, or at a relatively inexpensive initial cost alone.

### BRIEF DESCRIPTION OF THE FIGURES

The disclosure will be described in conjunction with the following figures, in which like numerals represent like elements, and in which:

FIG. 1 is a diagram illustrating the features of an exemplary embodiment of a charging system according to the invention.

### DETAILED DESCRIPTION

The figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in similar devices, systems, and methods. Those of ordinary skill may thus recognize that other elements and/or steps may be desirable or necessary to implement the devices, systems, and methods described herein. Because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art.

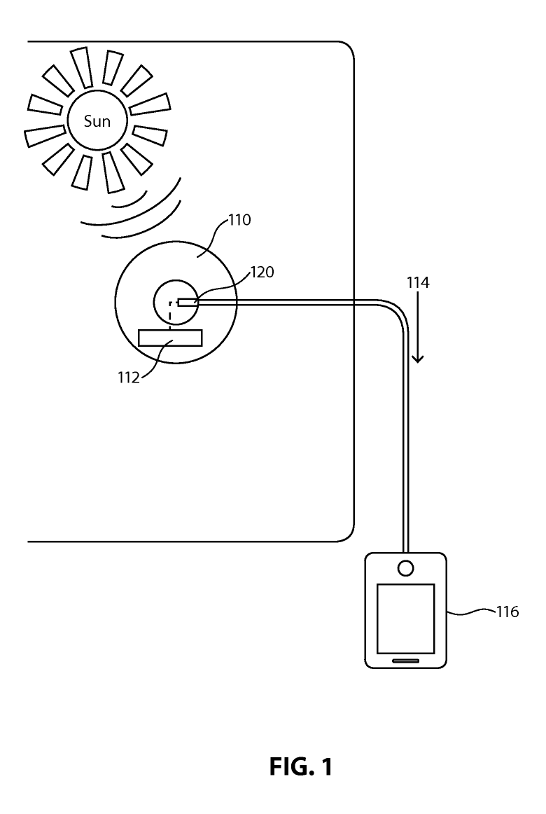

FIG. 1 is a diagram illustrating an exemplary embodiment of the instant invention. As is evident in FIG. 1, the system of present invention may include an attachment mechanism 110 for placing a solar, vibration, or like sensor 112 into a situation whereby the sensor will receive that stimulation which is needed to generate an electrical current 114 for charging a mobile device 116. For example, in a solar sensor 112 embodiment, a solar cell 112 may receive energy from the sun, and may generate therefrom an electrical current that represents the conversion of the solar energy to electricity. Likewise, a vibration sensor 112, such as a transducer, may receive kinetic energy, such as in the form of movement or vibration, and may convert that kinematic energy into electricity.

The attachment mechanism 110 may include, for example, a suction cup, a reusable adhesive, or the like. The electricity generating sensor 112 may be associated with the attachment mechanism and may be thereby attached into an environment whereby the sensor is sufficiently stimulated to generate electricity. For example, in a suction cup 110 and solar cell 112 embodiment, the solar cell may be embed within, or mounted on, the suction cup, and the suction cup may be suitably attached to a window that is receiving or will receive sunlight, such as an airplane window. Likewise, a mounting attachment having a preferably reusable light adhesive may be attached to, for example, an airplane meal tray or an airplane armrest in a position such that sunlight will be received. Yet further, and by way of nonlimiting example, a circular mount having associated therewith a vibration transducer maybe attached to an area of an airplane wall adjacent to a window, whereby vibrations upon the outer surface of the airplane will be transduced to electricity, and/or whereby sunlight may be received. Those skilled in the pertinent arts will appreciate that the attachment mechanism may be of any shape suitable for temporary attachment to a desirable surface. Moreover, those skilled in the pertinent arts will appreciate that multiple different sensors 112 may be included on, or otherwise associated with, a single mount of attachment mechanism 110, or with multiple mounts, or with multiple attachment mechanisms, such as to provide various charging capabilities within a single charging device and system.

In a more particular exemplary embodiment, the electricity generating sensor 112 associated with the attachment mechanism 110 may be well suited for portability and mounting, such as mounting to a suction cup, without being sufficiently heavy to pull a suction cup off of a window mounting surface. Accordingly, a thin filament solar paper may be employed as the “solar cell” or “solar sensor” discussed herein. Such a thin filament solar paper is sufficiently light so as to not affect the mountability of a suction cup to a window, but is still sufficiently sensitive so as to capture solar energy and convert that energy to electricity suitable for charging a connected mobile device.

The sensor 112 may be mounted to attachment mechanism by any suitable means. For example, sensor 112 may be embedded within the mount, or adhered to a surface of its mount, such as covered by a protective layer. In any case, it is preferable that the mounting of the sensor 112 not interfere with its functionality. For example, a sensor 112 that senses kinetic energy should not be so embedded in a mount that its ability to sense kinetic energy is insulated, and likewise a solar sensor should not be deeply embedded in an insulating, such as a thick or heavily colored, mount.

Additionally associated with the attachment mechanism having mounted thereto the electricity generating sensor may be a port 120 suitable for providing the generated electricity to the mobile device. Such a port may comprise a hardwired wire electrically connected to, and hence suitable for receiving the electricity generated from, the sensor, wherein such energy may be collected in a capacitor or the like. The port 120 may additionally be or include, by way of nonlimiting example, a micro USB, mini USB, USB, proprietary, or like port into which a user's mobile device charging cord may be inserted. Yet further, the output port of the electricity generating sensor may run through a wire to, or may otherwise include within its circuit, a transformer, or the like, which may be physically disassociated with the attachment mechanism but-for the wire that passes the electricity generated from the sensor to the transformer.

As is evident based on the foregoing disclosure, the generated electricity may ultimately be output, either from a hard wire connected to the sensor by the attachment mechanism, or by a plug inserted into the output port, to the mobile device for charging of the mobile device. Such ultimate charging may be provided to the mobile device by, for example, a micro USB, mini USB, USB, one or more proprietary plugs, or the like, that are accepted and those physically received by a port in the device.

Although the invention has been described and illustrated in exemplary forms with a certain degree of particularity, it is noted that the description and illustrations have been made by way of example only. Numerous changes in the details of construction, combination, and arrangement of parts and steps may be made. Accordingly, such changes are intended to be included within the scope of the disclosure, the protected scope of which is defined by the claims.

What is claimed is:

1. A charging apparatus capable of charging a mobile device, comprising:
an attachment mechanism capable of attaching to a surface;
a sensor associated with said attachment mechanism and capable of receiving energy generated upon the surface, wherein the received energy is converted to electrical current; and
a port electrically communicative with said sensor and capable of receiving the electrical current, and of providing that electrical current to the mobile device.
